(19) United States
(12) Patent Application Publication
(10) Pub. No.: US 2026/0302113 A1
(43) Pub. Date: Oct. 1, 2026

(54) SPRING ELEMENT FOR A TEMPERATURE-DEPENDENT SWITCH, AND TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 19/629,639

(22) Filed: Mar. 26, 2026

(30) Foreign Application Priority Data
Mar. 26, 2025 (DE) 10 2025 111 656.3

(51) Int. Cl. H01H 37/54

(52) U.S. Cl. CPC H01H 37/5427; H01H 2037/5481; H01H 2037/549

(57) ABSTRACT

A spring element for a temperature-dependent switching mechanism of a temperature-dependent switch. The spring element has a convexly curved upper side and a concavely curved lower side, and is made of an electrically conductive material, in particular metal. The spring element comprises a plurality of distributed beads and/or stiffening struts that are arranged to form local reinforcements.

### CROSS-REFERENCE TO RELATED APPLICATIONS

This application claims priority from German patent application DE 10 2025 111 656.3 filed on Mar. 26, 2025. The entire content of this priority application is incorporated herein by reference.

### FIELD

This disclosure relates to a spring element for a temperature-dependent switching mechanism of a temperature-dependent switch. Furthermore, the present disclosure relates to a temperature-dependent switch, the temperature-dependent switching mechanism of which comprises the spring element.

An exemplary temperature-dependent switch is disclosed in DE 10 2013 109 291 A1.

Such temperature-dependent switches serve, in a manner known per se, to monitor the temperature of a device. For this purpose, the switch is brought into thermal contact with the device to be protected, for example via one of the outer surfaces of said switch, such that the temperature of the device to be protected influences the temperature of the switching mechanism arranged inside the switch.

The switch is typically connected electrically in series into the supply circuit of the device to be protected via connecting lines, so that below the response temperature of the switch, the supply current of the device to be protected flows through the switch.

The temperature-dependent switching mechanism arranged inside the switch provides the temperature-dependent switching behavior of the switch. In the closed switch state, the switching mechanism presses a movable contact part against at least one stationary contact, thus establishing an electrical connection between the two external terminals of the switch. In the open switch state, on the other hand, the switching mechanism keeps the movable contact part at a distance from the at least one stationary contact, so that the electrical connection between the two external terminals of the switch is disconnected.

The switching behavior, i.e., the switching between the closed switch state and the open switch state, occurs in a temperature-dependent manner. A bimetallic element is typically responsible for the temperature-dependent switching behavior of the switching mechanism, which in a known manner switches or snaps in a temperature-dependent manner in the manner of a hysteresis between two configurations, a low-temperature configuration or a low-temperature position and a high-temperature configuration or a high-temperature position.

If the temperature of the bimetallic element increases as a result of a temperature increase in the device to be protected above a defined temperature, which is referred to as the response temperature or switching temperature of the bimetallic element, the bimetallic element snaps from its low-temperature configuration to its high-temperature configuration, thereby causing a switching operation closed switch state to the open switch state or vice versa. Depending on the type of installation, the switch can be designed such that it is in the closed switch state below the response or switching temperature, which is referred to as “normally closed”, or instead is then in the open switch state, which is typically referred to as “normally open”.

In most of these temperature-dependent switches, a spring element is used in the temperature-dependent switching mechanism in addition to the bimetallic element. This spring element is typically referred to as a “temperature-independent spring element” because, unlike the bimetallic element, its behavior is independent of temperature.

This spring element typically serves to relieve the bimetallic element, both mechanically and electrically. In the closed switch state, it typically exerts the contact pressure by means of which the movable contact part is pressed against the at least one stationary contact. In addition, it conducts the electric current in the closed switch state. In the case of using such a spring element, the bimetallic element can thus be mounted mechanically force-free in the closed switch state and, moreover, does not have to serve as a current-carrying component. This has an enormously positive effect on the service life of the bimetallic element.

The spring element is often designed as a snap disc and has a convex-concave shape. The actuating force of the spring element is usually determined by the material thickness as well as the curvature height of the spring element. In particular, the curvature height or the curvature of the spring element poses structural challenges for the design of the temperature-dependent switch. The curvature height or curvature of the spring element should be adapted to the tolerances of the other components of the temperature-dependent switching mechanism. In particular, the curvature height and curvature of the spring element should be adapted to the curvature height and curvature of the bimetal element, which, like the curvature height and curvature of the spring element, is subject to manufacturing-related variations. The challenge therefore often lies in compensating for different curvature heights through tolerance adjustments or dimensional adjustments, which requires a high variety of variants in the individual components of the temperature-dependent switching mechanism. Furthermore, this not only increases the assembly effort, but also the subsequent testing effort.

Furthermore, such spring elements are usually very small, only a few millimeters in size, fragile components that are stored and transported as bulk material after their manufacture. In this type of bulk goods storage, electrostatic adhesions may occur due to friction, which adhesions can have a negative impact during the assembly process.

Due to such adhesions, it is necessary that the individual spring elements must be singularized or separated from each other in a time-consuming manner before being inserted into the switch housing. If the switching elements overlap precisely, it may even be the case that two such switching elements are accidentally inserted into the switch, instead of just one, and this only becomes apparent later, i.e., after the switch has been assembled, due to malfunctions. Even fitters, with their well-trained eyes, make this type of mistake from time to time, resulting in time-consuming and costly follow-up checks for safety reasons.

Furthermore, the relevant spring elements usually undergo a hardening process before assembly. This hardening process is typically carried out in a furnace under protective gas. Overlapping and adhesion of the individual spring elements can therefore lead to irregular or insufficient hardening results. For example, traces of oxygen may remain in the system or on the surfaces of the spring elements. This is particularly critical if the surfaces of the spring elements are coated with an additional metal layer, e.g., a silver layer, to improve conductivity.

Therefore, it is essential to spread the spring elements to be hardened in several levels in the hardening furnace, and usually to ensure manually that they do not overlap or adhere to one another. Otherwise, the protective gas cannot reach every spring element from all sides. The separation process required for this is also time-consuming and furthermore reduces furnace capacity. Furthermore, an increased consumption of protective gas is necessary, which in turn is costly.

In the case of fully automated feeding of the spring elements, the overlapping, as well as the precise adhesion of the spring elements, presents a problem insofar as singularization by means of vibrating pot feeding or magazining only inadequately solves the problem. Therefore, similar problems to those already explained above also arise for the manual assembly of the spring elements. As a result, time-consuming and therefore costly follow-up checks are necessary here as well, which is why fully automated assembly of the spring elements has mostly proven to be uneconomical so far, and why a large number of manual assembly processes still have to be used when assembling such temperature-dependent switches.

### SUMMARY

It is an object to provide a spring element which can overcome or at least largely eliminate the aforementioned disadvantages. In particular, one object is to provide a spring element of which the actuating force is not only defined by its height and material thickness, so that its actuating force can be varied as easily as possible through minor modifications. Furthermore, the adhesion or overlapping of the spring elements described above should be prevented as effectively as possible during bulk material storage and/or during a hardening process.

According to a first aspect, a spring element for a temperature-dependent switching mechanism of a temperature-dependent switch is presented. The spring element has a convexly curved upper side and a concavely curved lower side, and the spring element comprises a plurality of beads and/or stiffening struts, wherein the beads and/or the stiffening struts form local reinforcements.

The stiffness and, consequently, the spring elasticity of the spring element can be adjusted relatively easily by means of the beads or stiffening struts. Contrary to the general tendency to avoid such stiffening elements in a spring element in order not to restrict its spring elasticity, the inventor has thus found a way to adjust the actuating force of the spring element in a simple manner. The actuating force of the spring element can be varied by appropriately varying the shape and/or size of the beads or stiffening struts.

Thus, it is possible to adapt the spring element to the desired actuating force by adjusting the shape and/or size of the beads or stiffening struts. The longer or larger the beads or stiffening struts are, the stiffer the spring element becomes and the greater its actuating force. The shorter and smaller the beads or stiffening struts are, the larger the remaining elastic area of the spring element and the lower its actuating force.

Thus, it is possible to provide one and the same spring element with beads or stiffening struts of different sizes or lengths in order to adjust the actuating force of the spring element. For example, spring elements of the same design with beads or stiffening struts of different shapes, different lengths and/or provided in different numbers can be kept in stock in order to insert a spring element with the desired spring or stiffness behavior into the temperature-dependent switch, depending on the desired switching behavior of the temperature-dependent switching mechanism or to compensate for tolerances of other components.

Furthermore, it has been shown that a spring element with such beads or stiffening struts is easier to store as bulk material, since the danger of several such spring elements sticking together, as described at the outset, is minimized. The beads or stiffening struts create local unevenness on the convexly curved upper side and/or the concavely curved lower side of the spring element. These unevennesses also act as spacer elements, so that smaller gaps are created between the spring elements when said elements are stacked on top of each other. This does slightly increase the volume for bulk material storage. However, the individual spring elements can be separated from each other much more easily during assembly. This thus also significantly simplifies the fully automated singularization of the spring elements provided as bulk material. This can virtually eliminate the possibility of accidentally inserting two spring elements instead of just one spring element into the temperature-dependent switch, whether manually or fully automatically.

Because the beads or stiffening struts act as spacer elements, the hardening process described at the outset is also simplified. During the hardening process, the protective gas used can thus reach almost all parts of the spring elements specifically much more uniformly, with the result that better hardening results can be achieved.

In this context, a “bead” is understood to be a channel-shaped, elongate depression or elevation that serves to stiffen. The bead is introduced into the spring element by forming, preferably by embossing or rolling.

In this context, a “stiffening strut” is understood to be an elongate component that also serves to locally stiffen the spring element, but which, in contrast to a bead, is a separate component that is attached to the spring element, for example, in an integrally bonded manner. In principle, such a stiffening strut can also be integrally connected to the spring element, i.e., in one piece. Even then, compared to a bead, it is a separate addition of material or an increase and not merely a deformation in the spring element created by embossing or rolling.

According to a refinement, the beads or stiffening struts are arranged distributed symmetrically around the center of the spring element.

Preferably, the beads or stiffening struts are arranged distributed rotationally symmetrically about a central middle axis of the spring element.

This has the particular advantage that the influences of the beads or stiffening struts have a uniform or symmetrical effect on the spring behavior and stiffness behavior of the spring element. In addition, the beads or stiffening struts ensure a uniform support for other spring elements that lie above them during bulk material storage. Furthermore, this intentionally leaves a degree of freedom (rotation about the middle axis of the spring element) during assembly.

According to a further refinement, the beads or stiffening struts are designed to be straight. This means that each bead or stiffening strut runs along a straight line. The longitudinal axis of each bead or stiffening strut is accordingly straight (i.e., uncurved).

In the case of straight-shaped beads or stiffening struts, it is particularly preferred that the beads and/or stiffening struts each run along a radial direction of the spring element, i.e., from the inside to the outside. This refers in particular to the plan view of the spring element from above or below along the middle axis of the spring element. In this plan view, the beads or stiffening struts run radially from the inside to the outside.

According to an alternative refinement, the beads and/or stiffening struts are circular and run concentrically to each other.

This refinement also has the advantage that the increase in stiffness caused by the beads and/or stiffening struts is evenly distributed and the spring properties of the spring element are maintained as uniformly as possible.

In the case of the stiffening elements being designed as beads, these are preferably formed into the spring element, in particular embossed or rolled in. In the case of the stiffening elements being designed as stiffening struts, these are preferably attached to the upper side and/or the lower side of the spring element.

According to a further refinement, the spring element has two, three, four, five or six of the beads and/or stiffening struts. Although it is generally possible for the spring element to have both beads and stiffening struts, it is preferred that the spring element has either beads or stiffening struts. For example, the spring element has two, three, four, five or six beads, or alternatively, the spring element has two, three, four, five or six stiffening struts.

The beads particularly preferably each have a substantially U-shaped cross section. This U-shaped cross section is preferably rounded, but can also be angular.

The term “cross section” of the bead refers to the section perpendicular (transverse) to the longitudinal axis of the bead.

According to a further refinement, the spring element is preferably made of steel or copper-beryllium.

According to a further refinement, the spring element is designed substantially in the shape of a circular ring or circular disk in plan view.

In such a circular ring-shaped or circular disc-shaped design of the spring element, the beads and/or stiffening struts provided prove to be particularly advantageous if they are designed to be rotationally symmetrical to the central middle axis of the spring element.

However, the spring element does not necessarily have to be designed in the shape of a circular ring or circular disk. The switching element is typically adapted to the shape of the switch housing and can, for example, be oval or substantially rectangular. The spring element can, for example, also be designed as a three-legged or four-legged spring.

According to a further refinement, the spring element has a hole or a contact element protruding from the upper side in its center. The second alternative mentioned above corresponds to a direct attachment of the movable contact part to the spring element. According to the first variant, the movable contact part is passed through the hole when the temperature-dependent switch is mounted. When the switch is mounted the spring element, with its central hole, can be loosely placed over the movable contact part, attached thereto captively but with play, or fixedly connected to the movable contact part.

According to a second aspect, a temperature-dependent switch is presented, comprising two external terminals; and a temperature-dependent switching mechanism configured to switch, depending on its temperature, between a closed switch state, in which an electrically conductive connection is established between the two external terminals, and an open switch state, in which the electrically conductive connection is interrupted. The temperature-dependent switching mechanism comprises a spring element having a convexly curved upper side and a concavely curved lower side, the spring element comprising a plurality of beads and/or stiffening struts, wherein the beads and/or the stiffening struts form local reinforcements.

According to a preferred refinement of the temperature-dependent switch, the switching mechanism has a static contact and a movable contact part, the spring element being operatively connected to the movable contact part in such a way that it presses the movable contact part against the static contact in the closed switch state and/or keeps it spaced apart from the static contact in the open switch state.

According to a further refinement, the temperature-dependent switching mechanism also features a temperature-dependent bimetal element.

Of course, the features mentioned above and those still to be explained below can be used not only in the combination specified in each case but also in other combinations or on their own without departing from the spirit and scope of the present disclosure.

### BRIEF DESCRIPTION OF THE DRAWINGS

FIG. 1 is a plan view from above of a first exemplary embodiment of a spring element;

FIG. 2 is a sectional view of the spring element shown in FIG. 1 according to the first exemplary embodiment along the line of section A-A indicated in FIG. 1;

FIGS. 3A and 3B are two different possible cross sections along the line of section B-B indicated in FIG. 1;

FIG. 4 is a sectional view of a second exemplary embodiment of the spring element, which corresponds to the sectional view shown in FIG. 2;

FIG. 5 is a plan view from above of a third exemplary embodiment of the spring element;

FIG. 6 is a sectional view of the spring element shown in FIG. 5 along the line of section C-C shown in FIG. 5;

FIG. 7 is a schematic sectional view of an exemplary embodiment of a switch, the switch being in the closed switch state; and

FIG. 8 is a schematic sectional view of the switch shown in FIG. 7, the switch being in the open switch state.

### DESCRIPTION OF PREFERRED EMBODIMENTS

FIG. 1-3 show a first exemplary embodiment of the spring element in different views. Therein, the spring element is denoted in its entirety by reference sign 10.

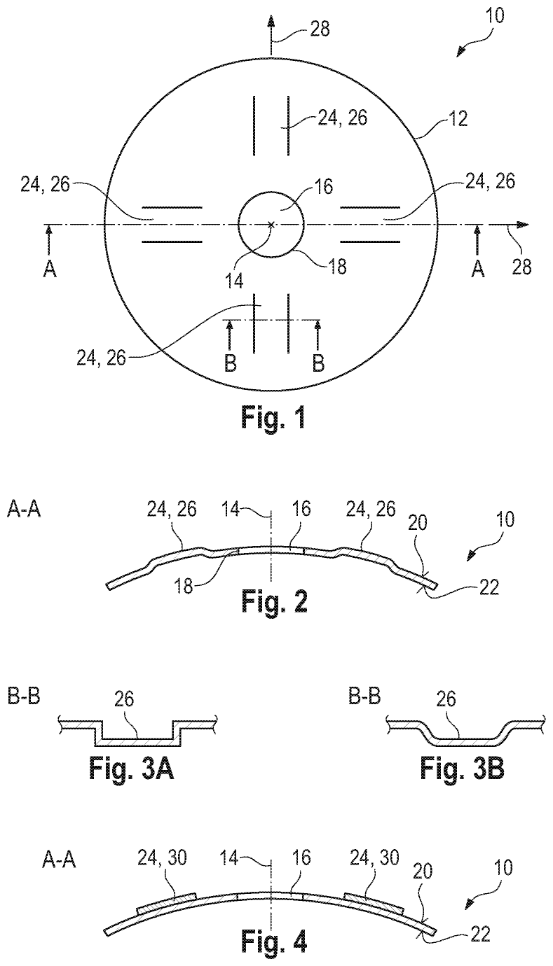

FIG. 1 shows the spring element 10 in a plan view from above. FIG. 2 shows the spring element 10 in a sectional view along the line of section A-A indicated in FIG. 1. FIGS. 3A and 3B show two different possible cross-sectional shapes along the line of section B-B indicated in FIG. 1.

The spring element 10 is typically made of metal. The spring element 10 is particularly preferably made of steel or copper-beryllium.

In the first embodiment shown in FIG. 1, the spring element 10 has a circular disk-shaped outer contour in the plan view from above. In other words, the circumferential outer edge 12 of the spring element 10 runs along a circular line. At its center, the spring element 10 has a circular hole 16 that extends around a central middle axis 14 of the spring element 10. The radially inner edge 18 of the spring element 10 also runs accordingly along a circular line. The spring element 10, viewed as a whole, is thus circular ring-shaped in the plan view.

The central middle axis forms an axis of symmetry with respect to which the spring element 10 is designed to be rotationally symmetrical. In the exemplary embodiment shown in FIG. 1, the spring element 10 is rotationally symmetrical about the middle axis 14 at 90°.

As can be seen in particular from FIG. 2, the spring element 10 is convex-concavely curved. The spring element 10 has a convexly curved upper side 20 and a concavely curved lower side 22, which is opposite the upper side 20.

Furthermore, the spring element 10 according to the first exemplary embodiment shown in FIGS. 1 and 2 has four evenly distributed stiffening elements 24. According to the first exemplary embodiment, the stiffening elements 24 are designed as elongate, straight beads 26. These beads 26 provide local stiffening of the spring element 10. They are embossed or rolled into the spring element.

Each of these beads 26 extends along a radial direction 28 of the spring element 10. This radial direction is indicated in FIG. 1 by arrows 28. In other words, the beads 26 extend in a star shape from the inside out. Since the spring element 10 has the aforementioned convex-concave curvature indicated in FIG. 2, the beads 26 do not strictly speaking run exactly in the radial direction 28, i.e., not exactly perpendicular to the middle axis 14. Only in the plan view do the beads 26 run exactly in the radial direction 28.

FIGS. 3A and 3B show two possible cross-sectional shapes of the beads 26. FIG. 3A shows a rectangular cross-sectional shape of the bead 26. FIG. 3B shows a rounded cross-sectional shape of the bead 26. Both cross-sectional shapes shown in FIGS. 3A and 3B can be described as substantially U-shaped.

Apart from the beads 26, the spring element 10 is preferably curved in an arc shape on both its upper side 20 and its lower side 22 and particularly preferably has a constant curvature.

FIG. 4 shows a second exemplary embodiment of the spring element 10 in a sectional view corresponding to the sectional view in FIG. 2, i.e., along the line of section A-A shown in FIG. 1. In contrast to the first exemplary embodiment shown in FIG. 2, the stiffening elements 24 distributed on the spring element 10 are not formed as beads 26 in the spring element 10, but are designed as stiffening struts 30 attached to the upper side 20 of the spring element 10. The stiffening struts 30 are also elongated and, in plan view, run along the radial direction 28.

The stiffening struts can either be integral, i.e., formed in one piece with the spring element 10, or attached to it. For example, the stiffening struts 30 can be attached to the spring element 10 by means of a material bond.

The stiffening struts 30 do not necessarily have to be arranged on the upper side 20. They can also be arranged on the lower side 22.

In a variation of the first two exemplary embodiments shown in FIG. 1-4, of course more than four stiffening elements 24 can also be provided on the spring element 10 (e.g., five, six, seven or eight). Likewise, fewer than four stiffening elements 24 can be arranged on the spring element 10 (e.g., two or three). If the stiffening elements 24 are designed as beads, the beads do not necessarily have to be raised upwards, i.e., towards the upper side 20 of the spring element 10 and recessed towards the lower side 22 of the spring element 10, but can also be recessed on the upper side 20 of the spring element and raised on the lower side 22 of the spring element 10. It is also possible that the spring element 10 has both beads 26 and stiffening struts 30 as stiffening elements 24.

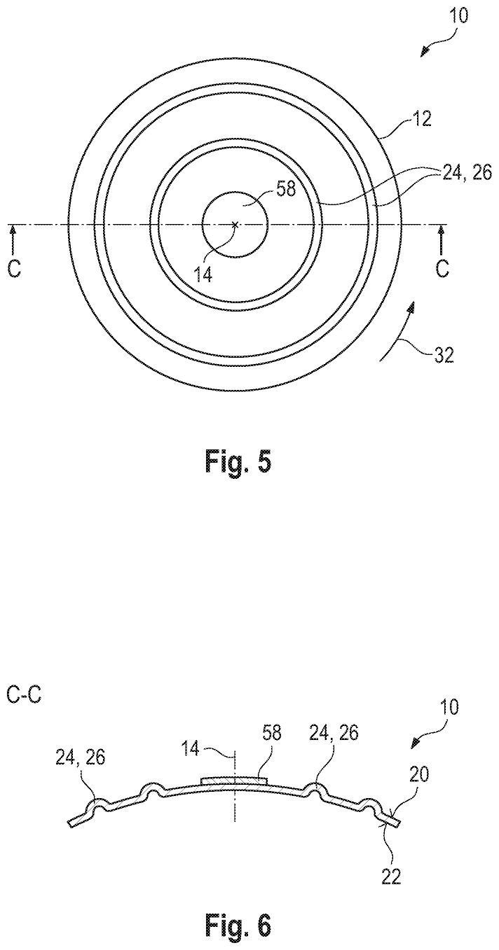

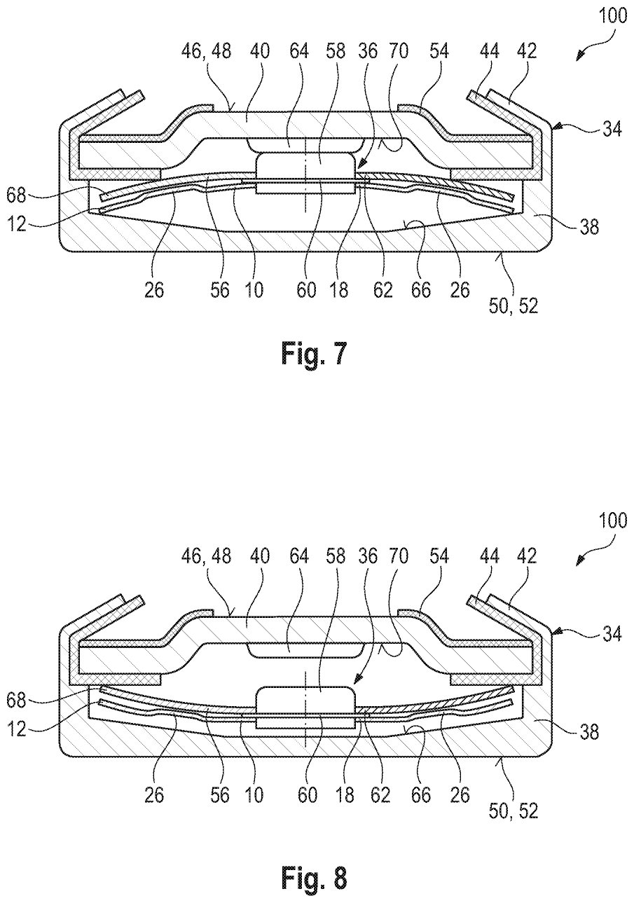

FIGS. 5 and 6 show a third exemplary embodiment of the spring element 10. The spring element 10 is designed in a circular disc shape. Instead of a central hole, a contact part 58 is attached directly to the spring element 10. This contact part 58 is often referred to as the “movable contact part” because it moves together with the spring element 10 during a switching operation. In the exemplary embodiments of the spring element 10 shown in FIG. 1-4, which are provided with a central hole 16, the movable contact part 58 is passed through the hole 16, as is the case, for example, with the switch 100 shown in FIGS. 7 and 8.

In the exemplary embodiment of the spring element 10 shown in FIGS. 5 and 6, the stiffening elements 24 are again designed as beads 26. However, the beads 26 each run here in the circumferential direction 32. Each of these beads 26 forms a closed, circular ring-shaped contour. The individual beads 26 run concentrically to each other.

FIGS. 7 and 8 show an exemplary embodiment of a temperature-dependent switch 100 in which the spring element 10 is used. FIG. 7 shows the closed switch state of the switch 100. FIG. 8 shows the open switch state of the switch 100.

Of course, the switch 100 shown in FIGS. 7 and 8 is only one example of various possible temperature-dependent switches in which the spring element 10 can be used.

The switch 100 has a switch housing 34, inside which a temperature-dependent switching mechanism 36 is arranged. The switch housing 34 comprises a pot-shaped lower part 38 and a cover part 40, which is held on the lower part 38 by a bent or crimped upper edge 42.

In the exemplary embodiment of the switch 100 shown in FIGS. 7 and 8, both the lower part 38 and the cover part 40 are made of an electrically conductive material, preferably metal. An insulating film 44 is arranged between the lower part 38 and the cover part 40. The insulating film 44 ensures electrical insulation of the lower part 38 from the cover part 40. Likewise, the insulating film 44 ensures a mechanical seal that prevents liquids or impurities from entering the interior of the switch housing 34 from the outside.

Since in this example the lower part 38 and the cover part 40 are each made of electrically conductive material, thermal contact can be established with a device to be protected, via their outer surfaces. The outer surfaces simultaneously also serve as the electrical terminal for the switch 100. For example, the outer surface 46 of the cover part 40 can function as the first electrical external terminal 48 and the outer side 50 of the lower part 38 can function as the second external terminal 52.

A further insulating layer 54 is arranged on the outside of the cover part 40.

The switching mechanism 36 is arranged clamped between the lower part 38 and the cover part 40. The switching mechanism 36 has a bimetal element 56 and a movable contact part 58 in addition to the spring element 10. The movable contact part 58 is guided through a central hole provided in the bimetal element 56, as well as through the central hole 16 provided in the spring element 10. A peripheral, circular disk-shaped collar 60, which is arranged approximately centrally on the movable contact part 58, separates the bimetal element 56 from the spring element 10. The bimetal element 56 rests with its inner edge 62 against the collar 60 of the movable contact part 58. The spring element 10 rests with its inner edge 18 against the collar 60 of the movable contact part 58 from below.

In the closed switch state of the switch 100 shown in FIG. 7, the spring element 10 presses the movable contact part 58 from below against a stationary mating contact 64 arranged on the cover part 40. This stationary mating contact 64 is also frequently referred to as the “static contact” 64 of the switch 100. In this case, the spring element 10 rests with its outer edge 12 on the inner base 66 of the lower part 38.

In this switch state of the switch 100, the bimetal element 56 preferably rests freely with its inner edge 62 on the collar 60 of the movable contact part 58, from above. The outer, peripheral edge 68 of the bimetal element 56 hangs freely into the inside of the housing 34. The bimetal element 56 is thus mounted in the switch housing 34, in the closed switch state of the switch 100, with virtually no force, without being firmly clamped therein.

In the closed switch state of the switch 100 shown in FIG. 7, the temperature-dependent switching mechanism 36 establishes an electrically conductive connection between the two external terminals 48, 52 of the switch 100 in that the movable contact part 58 is pressed against the stationary mating contact 64 arranged on the cover part 40. The contact pressure with which the movable contact part 58 is pressed against the stationary contact part 64 in the closed switch state of the switch 100 is caused by the spring element 10 in the switch 100.

If the temperature of the device to be protected, and thus the temperature of the switch 100 and the bimetal element 56 arranged therein, now increases to or above the switching or response temperature of the bimetal element 56, then the bimetal element 56 snaps from its convex low-temperature configuration shown in FIG. 7 to its concave high-temperature configuration shown in FIG. 8. During this snapping process, the bimetal element 56 rests with its outer edge 68 against the lower side 70 of the cover part 40 and presses the movable contact part 58 downward with its inner edge 62. This lifts the movable contact part 58 away from the stationary contact part 64. As a result, the spring element 10 simultaneously bends downward at its center, so that the spring element 10 snaps from its first geometric configuration shown in FIG. 7 into its second geometric configuration shown in FIG. 8. The electrical connection, previously established via the switching mechanism 36, between the two external terminals 48, 52 of the switch 100 is thus interrupted.

The temperature-dependent switching mechanism 36 of the switch 100 is thus designed to establish and disconnect the electrically conductive connection between the two external terminals 48, 52, depending on the temperature.

Depending on the desired embodiment, the temperature-dependent switching mechanism 36 can either be configured as previously explained, namely that below the switching temperature of the bimetal element 56 the switching mechanism 36 assumes the closed switch state shown in FIG. 7 and above the switching temperature assumes the open switch state shown in FIG. 8, or vice versa. In the first case, reference is made to a switch with the “normally closed” configuration. In the second case, reference is made to a switch with the “normally open” configuration.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A spring element for a temperature-dependent switching mechanism of a temperature-dependent switch, the spring element having a convexly curved upper side and a concavely curved lower side, the spring element comprising a plurality of beads and/or stiffening struts, wherein the beads and/or the stiffening struts form local reinforcements.

2. The spring element of claim 1, wherein the beads and/or the stiffening struts are distributed symmetrically about a center of the spring element.

3. The spring element of claim 1, wherein the beads and/or the stiffening struts are straight.

4. The spring element of claim 3, wherein the beads and/or the stiffening extend in a radial direction of the spring element.

5. The spring element of claim 1, wherein the beads and/or the stiffening struts have a ring shape and are arranged concentrically.

6. The spring element of claim 1, wherein the beads are formed in the spring element.

7. The spring element of claim 1, wherein the stiffening struts are arranged on at least one of the upper side or the lower side of the spring element.

8. The spring element of claim 1, wherein the spring element comprises two, three, four, five or six beads and/or stiffening struts.

9. The spring element of claim 1, wherein the beads each have a substantially U-shaped cross section.

10. The spring element of claim 1, wherein at least a portion of the spring element is made of an electrically conductive material.

11. The spring element of claim 1, wherein at least a portion of the spring element is made of metal.

12. The spring element of claim 1, wherein at least a portion of the spring element is made of steel or copper-beryllium.

13. The spring element of claim 1, wherein the spring element is circular or annular.

14. The spring element of claim 1, wherein the spring element comprises, at a center thereof, a hole or a contact element that protrudes from the upper side.

15. A temperature-dependent switch, comprising:
two external terminals; and
a temperature-dependent switching mechanism configured to switch, depending on its temperature, between a closed switch state, in which an electrically conductive connection is established between the two external terminals, and an open switch state, in which the electrically conductive connection is interrupted,
wherein the temperature-dependent switching mechanism comprises a spring element having a convexly curved upper side and a concavely curved lower side, the spring element comprising a plurality of beads and/or stiffening struts, and the beads and/or the stiffening struts form local reinforcements.

16. The temperature-dependent switch of claim 15, wherein the temperature-dependent switching mechanism comprises a stationary contact and a movable contact part, the spring element is operatively connected to the movable contact part to press the movable contact part against the stationary contact in the closed switch state and/or to keep the movable contact part spaced apart from the stationary contact in the open switch state.

17. The temperature-dependent of claim 15, wherein the temperature-dependent switching mechanism comprises a bimetal element.
